(19) United States
(12) Patent Application Publication
(10) Pub. No.: US 2002/0073856 A1
(43) Pub. Date: Jun. 20, 2002

(54) Offset printing of gasket seals for wafer scale processing of microdisplays

(76) Inventors: Donald J. Davis, Conneaut Lake, PA (US); Scott Worthington, Hudson, OH (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/738,575

(22) Filed: Dec. 15, 2000

(51) Int. Cl. B41F 3/36; B41F 17/00

(52) U.S. Cl. 101/35; 101/158

(57) ABSTRACT

The invention involves the use of a novel offset-printing process to apply the gasket seal on microdisplay arrays in a wafer scale manufacturing process. Gasket seal material is applied to an anilox roll, which has a matrix pattern of indentations or cells at a fixed line screen spacing and depth which corresponds to the desired height of the gasket material prior to contact with the glass layer. The amount of gasket material transferred to the substrate is controlled by the volume of the cells of the anilox roll. The anilox roll continuously rotates and excess material not filling in the cells is removed from the roll by a doctor blade. A letterpress, attached to a print roll, rolls in contact with the anilox roll and material is transferred from the anilox roll onto the letterpress. Raised portions of the letterpress apply a gasket design to the substrate in accordance with the matrix of multiple microdisplay devices. The letterpress and print roll rotate in contact with the substrate as the substrate is translated under the print roll, thus applying the gasket material to the substrate in the desired pattern.

### FIELD OF THE INVENTION

This invention pertains to the manufacture of electronic display devices and, more particularly, to high throughput manufacturing processes for producing small liquid crystal on silicon (LCoS) display devices by wafer scale processing methods.

### BACKGROUND OF THE INVENTION

High throughput microdisplay manufacturing requires small gasket seal lines that avoid contact with the active area of the display. Microdisplays require narrow gasket seals and precise placement due to the small active area (typically less than 1″ diagonal) and tight packaging demands. Typically, a gasket seal with a cross-sectional area of 1000 square microns is desirable. Some microdisplay products have less than 6 mm 25 diagonal dimension yielding over 1500 parts on a 200 mm wafer. The inside surface of a microdisplay (for example, rubbed polyimide alignment layer) is critical in determining the electro-optic performance of the display and any contamination resulting from the cell assembly process, including the application of gasket seals about the active areas, will degrade the device operation and appearance.

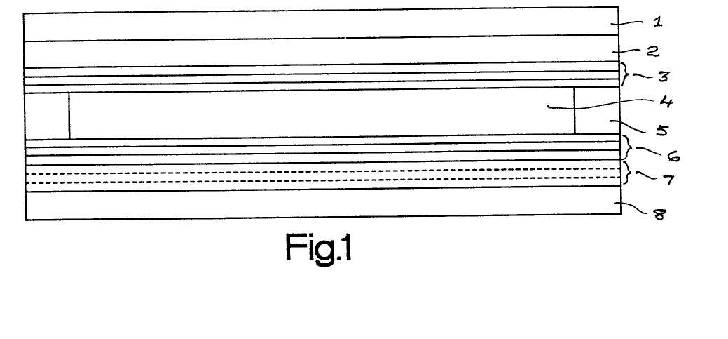

Microdisplays are a relatively new type of flat-panel display having a very small array of pixels, e.g. 10 mm×7 mm formed on a semiconductor substrate or back plane. With appropriate magnification, microdisplays appear comparable to conventional size monitors, when viewed at approximately twice the diagonal dimension of the array. FIG. 1 schematically illustrates a cross-section of a typical microdisplay, having a glass substrate 1, with an indium-tin-oxide (ITO) coating layer 2 which acts as a transparent conductor, polyimide alignment layers, 3 and 6, liquid crystal material 4, a perimeter gasket seal 5, and CMOS circuitry 7 on a silicon backplane 8. In certain alternate configurations the CMOS circuitry and silicon backplane are replaced by another piece of ITO coated glass. The gasket seal 5 is placed around the perimeter of the active area of the microdisplay to restrain the liquid crystal material and protect it from moisture, dirt and other contamination. The gasket is applied to one of the substrates in a narrow bead or line prior to the two substrates being mated together. A metal interconnect layer, e.g., AlSiO₂, used for conventional matrix addressing, provides a corresponding array of polished mirror surfaces to serve as the image plane of the display. Each mirror element is connected to a CMOS driver circuit through single or multiple voltage delivery vias. The metal interconnect layer also provides matrix addressing and circuitry for display addressing, control circuits, or image processing circuits.

In a typical manufacturing process, a passivation layer and an LCD alignment layer are applied to the top of the back plane. A gasket seal bead with a small fill port is dispensed around the periphery of the pixel array by screen printing or a syringe. A glass cover plate with a conductive transparent electrode film is fitted on the seal to form a liquid crystal display chamber. The chamber is filled through the fill port with liquid crystal material and the fill port is sealed.

Three different types of gasket seal application techniques can be used in LCD devices: direct dispensing, screen printing, and offset printing. In direct dispensing, the gasket seal material is loaded into a syringe or other pump type mechanism with a fine needle and mounted about the substrate on a x-y-z axis stage. The substrate is placed under the syringe on a vacuum stage. Nitrogen pressure is used to push material out of the syringe while the syringe moves, tracing out the gasket seal pattern. For high part counts per wafer, this can result in a long dispense/tack time. While gasket placement is very precise, height difference in the wafer or tolerance variations in the stages can result in the needle scratching the substrate. Tack time (i.e., the time required for the tool to perform its process on a substrate) for dispensing on 200 mm substrates with high part counts can take up to two hours

Screen-printing is an alternative to this process, in which gasket seal material is forced through a fine mesh which defines the location of the gasket on the substrate. This can result in the screen contacting the polyimide coating on the substrate and contaminating the polyimide surface. The throughput can be high with tack times less than 30 seconds, even for large panels. Screens with fine line geometries required for microdisplays are not durable enough for volume manufacturing and is the major problem for application of this method.

### SUMMARY OF THE INVENTION

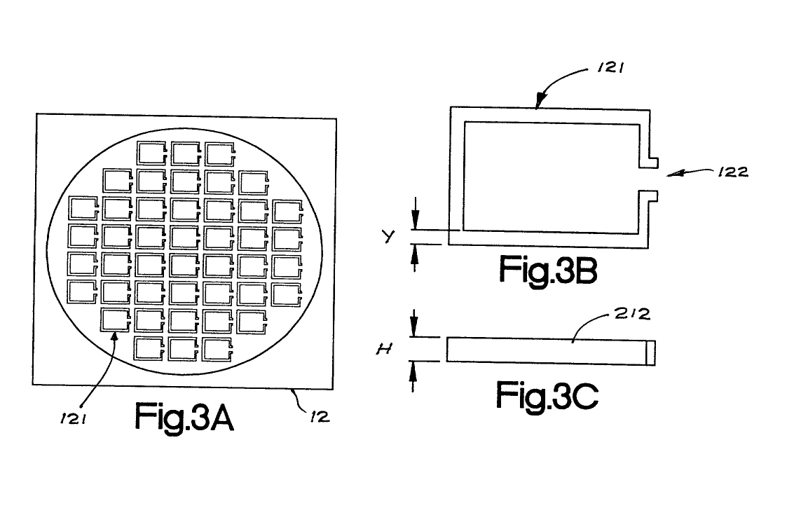

Offset printing is used in the LCD industry for application of polyimide alignment layers. Offset printers use a raised photopolymer letterpress that defines the print area, a print roll, an anilox roll, and a doctor blade to transfer the material to be printed on to the substrate. The material to be printed is first dispensed onto the anilox roll. Gasket seal materials with low thixotropic index are desired to prevent shear thinning during the printing process which can result in glue splatters on the substrate. The anilox roll has indentations, or cells, which are at a fixed spacing (line screen) and have a specific depth. The volume of material transferred to the substrate is controlled by the volume of these cells. The anilox roll continuously rotates and excess material not filling in the cells is removed from the toll by the doctor blade. The letterpress, which is attached to the print roll, rolls in contact with the anilox roll and material is transferred from the anilox roll onto the letterpress. The raised portion of the letterpress, shown in FIG. 3, is designed to place the gasket seal at the desired location on the substrate based upon the design requirements of a particular microdisplay. The letterpress and print roll rotate and contact the substrate as the substrate is translated under the print roll, thus completing the transfer of the printing material to the substrate.

The offset printing gasket seal application technique permits high throughput with high part count per substrate, narrow linewidths and cleanliness not obtainable with other techniques. Tack time for offset printing is about one minute, regardless of the number of parts on the substrate. Thermal cure or UV cure epoxies can be used in connection with offset printed gaskets, and with or without spacers mixed with the epoxy prior to printing.

### DETAILED DESCRIPTION OF PREFERRED AND ALTERNATE EMBODIMENTS

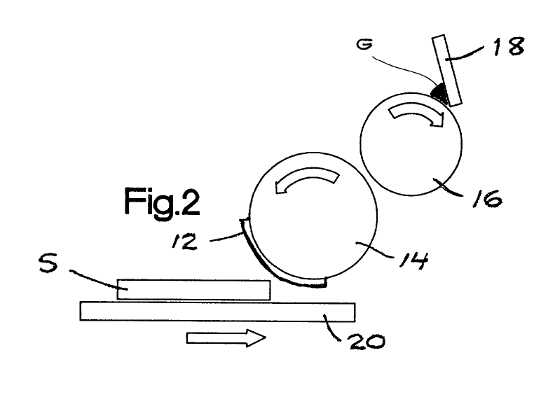

FIG. 2 schematically illustrates a system for application of a gasket seal to a microdisplay substrate for encapsulation of liquid crystal material. The basic components of the system include a letterpress 12 attached to a cylindrical print roll 14 which is mounted for rotational contact with a substrate S supported on a platen or print table 20. The diameter of the print roll may vary, and will determine the speed at which the print roll is rotated to control the speed of application of the gasket seals to the substrate, as further descirbed. A cylindrical anilox roll 16 is mounted for rotational contact with the print roll and letterpress, and a doctor blade 18 which is mounted for controlled contact with the anilox roll. The anilox roll 16 is configured to have indentations or cells which are at a fixed spacing (line screen) and a specific depth. The amount of gasket material G transferred to the substrate is determined by the volume of the cells. The anilox roll continuously rotates and excess material not filling in the cells is removed from the roll by the contact wiping action of the doctor blade.

The letterpress 12 is custom configured to the multiple gasket pattern of a matrix or array of gaskets for wafer scale manufacture of LCD displays, such as for example with a silicon wafer having a plurality of active areas or dies, typically arranged as a matrix of rectangles. FIGS. 3A-3B illustrate one possible letterpress design where the gasket seal patterns 121 are formed as raised portions 212 of the letterpress 12, corresponding to the location of multiple cell device backplanes. In this example, each gasket pattern is generally rectangular, with a fill port 122 on one side. The gasket seal design is preferably formed on the letterpress 12 by a photolithography process, in which a digital record (i.e., CAD drawing) of the letterpress design (based upon the die layout on the wafer) is applied, as controlled by appropriate computer hardware and software in connection with known photolithography processes and equipment, to a photosensitive polymeric material which becomes the letterpress or serves as a mold for the letterpress. For example, in the case of the gasket seal design of FIGS. 3A-3B, the lines defining each of the rectangular shapes are formed as raised areas (e.g., H=1 mm) on the photosensitive material, followed by a washout, so that the gasket seal patterns are formed as raised portions 212 of the letterpress 12.

With the letterpress so produced, it is then attached to the print roll, with the raised portions 212 projecting outward from the exterior of the print roll, so that as the print roll is brought into rolling contact with the substrate S the gasket seals patterns defined by the raised portions 212 of the letterpress 12 are applied to the substrate S at the correct locations. Positional error of the letterpress 12 on the print roll 14 is corrected by adjustment micrometers on the print table to precisely align the dies on the wafer with the letterpress 12. In this manner, the gasket seals 100 are applied to the substrate in a progressive rolling process, meaning that the entire seal or seals do not come into contact with the substrate S simultaneously, but progressively as the letterpress 12 is rolled against the substrate. Alternatively, the letterpress 12 is maintained in a planar state, and gasket material is applied to the raised portions 212, by for example an anilox roll, and the raised portions 212 of the letterpress 12 are then placed in contact with the substrate S in the correct locations about the active areas. Other suitable methods of transfer or application of gasket seal material G to the raised portions 212 of the letterpress 12 may be employed within the scope of the invention.

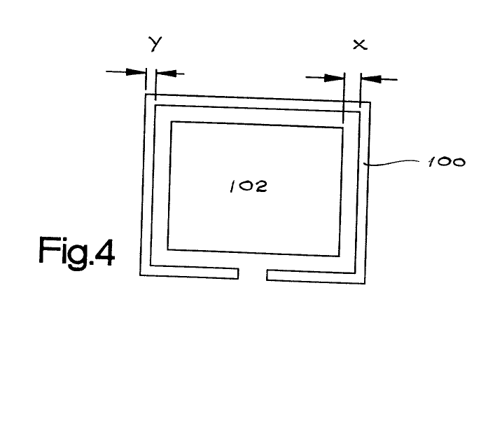

Computer aided design and manufacture of the letterpress 12 provides a flexible gasket seal design/build system in which unique gasket requirements for different types of display devices can be quickly produced. FIG. 4 illustrates a typical layout of a gasket seal 100 relative to the active area 102 of a microdisplay device, where X is the spacing distance between the active area 102 and the inner edge of the gasket seal 100, and Y is the thickness of the gasket seal 100. As these dimensions may change for any particular device design, they are input to the photolithography system for production of a custom letterpress 12 for wafer scale production of any particular device. This process is particularly advantageous for rapid manufacture of complex gasket designs which may have multiple legs and turns, particularly in the area of the fill port. Whereas each leg of a gasket layout requires an additional movement of a dispensing syringe, offset printing enables rapid deposit of any complex gasket design with no compromise in speed of application.

Claimed as the invention is:

1. A system for producing gasket seals on a substrate having one or more dies of active areas for liquid crystal display devices, the system comprising:
a source of gasket seal material for application to a cylindrical anilox roll having a volumetric capacity to carry gasket seal material,
a blade for removing excess gasket seal material from the anilox roll,
the anilox roll being mounted for rotational contact with a letterpress on a cylindrical print roll,
a letterpress attached to an exterior surface of the print roll, the letterpress having a raised portion which defines a gasket seal pattern which corresponds with a position of an active area of the substrate,
the print roll being mounted for rotational contact with a substrate supported on a print table.

2. The system of claim 1 wherein the letterpress has raised portions which define multiple gasket seal patterns.

3. The system of claim 1 wherein the letterpress is removable attached to the print roll.

4. The system of claim 1 wherein the letterpress has multiple gasket seal patterns arranged in a matrix.

5. The system of claim 1 wherein the print table is operative to translate relative to the print roll.

6. The system of claim 1 wherein the letterpress has a gasket seal pattern which includes a fill port.

7. The system of claim 1 wherein the letterpress is formed of a flexible material which is wrapped around the print roll.

8. The system of claim 1 wherein the letterpress is integral with the print roll.

9. The system of claim 1 wherein the letterpress has a gasket seal pattern which includes one or more legs which define a fill port.

10. The system of claim 1 wherein the letterpress has a raised portion which defines a gasket seal pattern which has a Y dimension which corresponds to a width of a gasket seal to be applied by the letterpress, and an X dimension which corresponds to a distance between an active area of the substrate and the gasket seal to be applied by the letterpress.

11. A letterpress configured to print one or more gasket seals about active areas on a substrate, the letterpress comprising:
a flexible generally planar material having a first surface adapted for attachment to a cylindrical print roll, and a second surface having raised portions, the raised portions defining one or more gasket seal patterns dimensioned to substantially surround an active area of a substrate.

12. The letterpress of claim 11 wherein the raised portions define a plurality of generally rectangular gasket seals which correspond in location to a plurality of active matrix areas of a substrate.

13. The letterpress of claim 11 wherein at least one of the gasket seal patterns includes one or more legs which define a fill port.

14. The letterpress of claim 11 in combination with a cylindrical print roll.

15. The letterpress of claim 11 wherein the raised portions define gasket seal patterns having a Y dimension which corresponds to a width of the gasket seals patterns defined by the letterpress to a substrate, and an X dimension which corresponds to a distance between active areas of the substrate and the gasket seals defined by the letterpress.

16. A method of applying gasket seals to a substrate having a plurality of active areas, wherein each active area is to be substantially surrounded by a gasket seal, and each gasket seal is made of a printable gasket seal material, the method comprising the steps of:
providing a letterpress having raised portions which define a plurality of gasket seal patterns which correspond to locations of active areas on a substrate, each gasket seal pattern being configured to substantially surround an active area, to have a defined width Y, and to be spaced a distance X from the active area, and to have a fill port in the form of an opening in the gasket seal pattern, the letterpress being formed by a photolithography process in which the raised portions of the letterpress are defined by a photolithography mask made according to the positions of the active areas of the substrate to which the gasket seals are to be applied by the letterpress,
applying a gasket seal material to the raised portions of the letterpress, placing the gasket seal material on the raised portions of the letterpress into contact with the substrate, moving the letterpress away from the substrate whereby the gasket seal material is transferred from the raised portions of the letterpress to the substrate to form gasket seals about the active areas of the substrate.

17. The method of claim 16 further comprising the step of using a computer file of dimension of the plurality of active areas to form the letterpress by a photolithography process.

18. The method of claim 16 wherein the gasket seal patter width Y is in the approximate range of 100 to 500 microns.

19. The method of claim 16 wherein the gasket seal material is applied to the letterpress in a rolling progressive process.

20. The method of claim 16 wherein the gasket seals are applied to the substrate in a rolling progressive process.

21. The method of claim 16 wherein the gasket seal material is applied to the letterpress by an anilox roll.

22. The method of claim 16 wherein the gasket seal material is applied to the anilox roll by a doctor blade.

23. The method of claim 16 wherein the gasket seals are applied to the substrate in a series of parallel rows.

24. The method of claim 16 further comprising the step of mounting the letterpress upon a print roll.

25. The method of claim 24 wherein the gasket seals are applied to the substrate at a rate determined by a rate of rotation of a print roll.

26. The method of claim 16 wherein the gasket seals are applied to the substrate in a progressive process wherein the fill port of the gasket seals are applied first to the substrate followed by a remainder of the gasket seal.
